(19) United States
(12) Patent Application Publication
(10) Pub. No.: US 2010/0150018 A1
(43) Pub. Date: Jun. 17, 2010

(54) System and Method for Testing User Connections in an Internet Protocol Television System

(75) Inventors: James G. Beattie, JR., Bergenfield, NJ (US); Mark Kenney, Woodbury, CT (US); Stephen J. Griesmer, Westfield, CT (US)

Correspondence Address: AT&T Legal Department - LNA;Attn: Patent Docketing, Room 2A- 207, One AT & T Way, Bedminster, NJ, 07921, US

(73) Assignee: AT&T CORP., New York, NY (US)

(21) Appl. No.: 12/333,837

(22) Filed: Dec. 12, 2008

(51) Int. Cl. H04L 12/26

(52) U.S. Cl. 370/253

(57) ABSTRACT

A method for providing a cable service dispatch ticket is disclosed. A new user installation request is received at a server in an Internet Protocol television system. An upstream data rate test is performed for each of a plurality of user connections in the Internet Protocol television system in response to the new user installation request. An upstream data rate that is determined for each of the user connections during the upstream data rate test is recorded. A cable service dispatch ticket for each of the plurality of user connections is provided when a number of the upstream data rates are below a threshold upstream data rate. A device that implements the method is also disclosed.

### FIELD OF THE DISCLOSURE

The present disclosure generally relates to communications networks, and more particularly relates to a system and method for testing user connections in an Internet Protocol television system.

### BACKGROUND

An Internet Protocol television (IPTV) service provider can transmit an IPTV signal to a user via a central office, a serving area interface, and a residential gateway. The serving area interface can provide multiple user connections between the central office and the different residential gateways. As the IPTV service is installed at a new user location, the IPTV signals on different user connections in the serving area interface can cause interference between the user connections.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an Internet Protocol Television (IPTV) system;

FIGS. 2 and 3 are block diagrams of an embodiment of an IPTV network;

FIG. 4 is a partial block diagram and a partial schematic diagram of a communication system associated with the IPTV network of FIG. 3;

FIG. 5 is a flow diagram of a method for testing upstream data rates for a plurality of user connections in the communication system of FIG. 4;

FIG. 6 is a flow diagram of an alternative method for testing the upstream data rates for the plurality of user connections in the communication system; and

FIG. 7 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

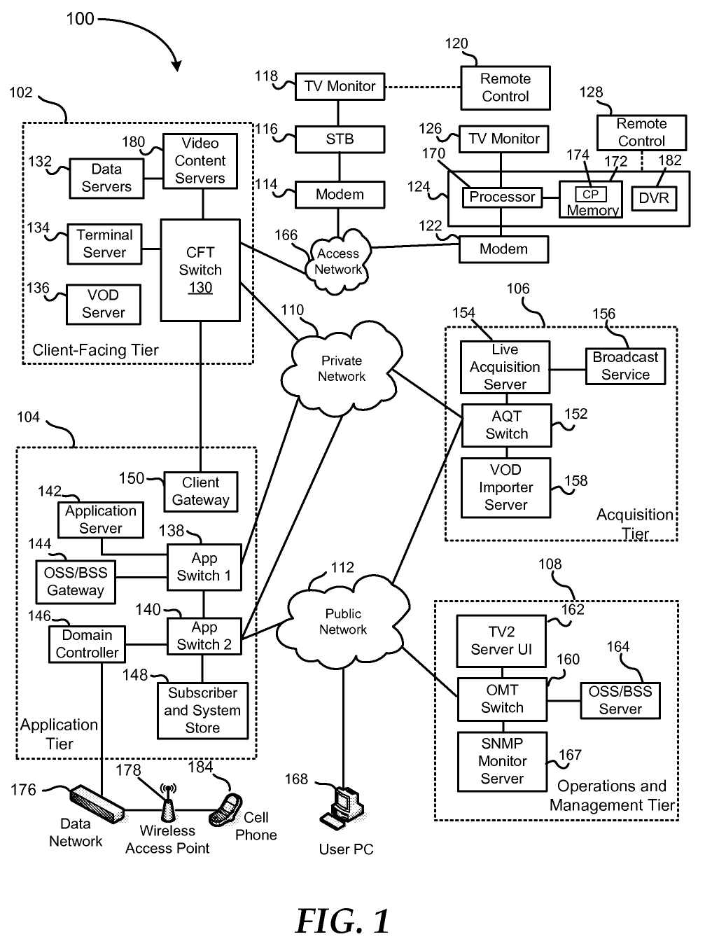

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106, and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the data servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

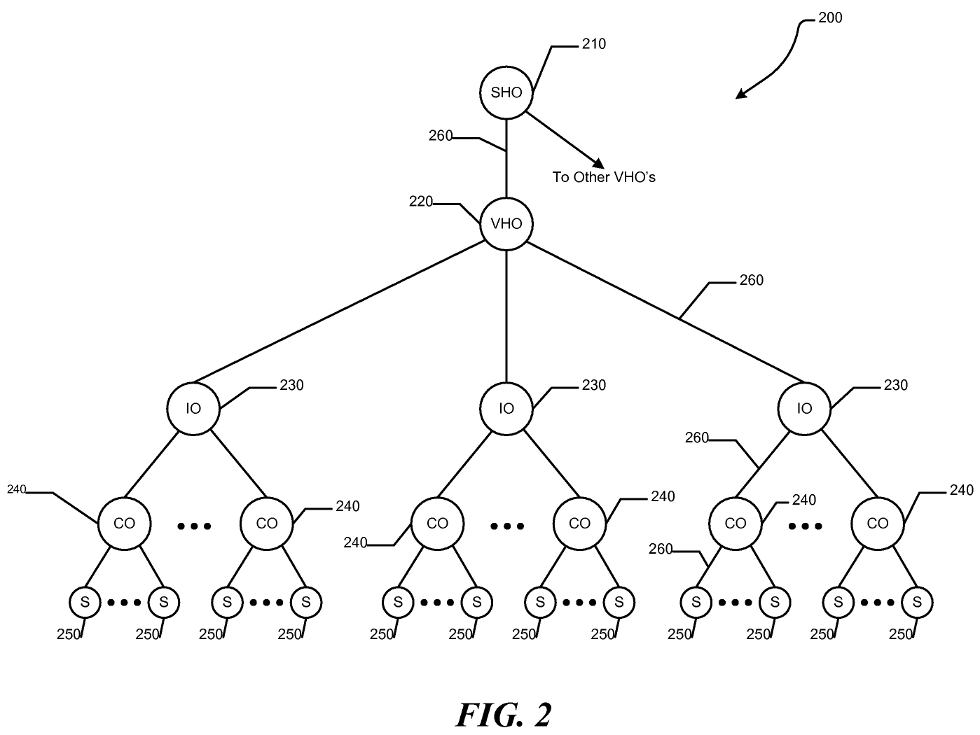

FIG. 2 shows one example embodiment of a television distribution system or network 200, using IPTV technology in this example but not limited thereto, adapted to provide, among other things, the live television content features of the disclosed subject matter. The network 200 may include a super hub office (SHO) 210 for acquisition and encoding of video content, one or more video hub offices (VHO) 220 in each demographic market area (DMA), one or more intermediate offices (IO) 230, one or more central offices (CO) 240 located in each metropolitan area, and subscribers 250, who may be located in single or multiple dwelling units. In one example embodiment, the network 200 may be connected through a plurality of high speed communication links 260 using physical transport layers such as fiber, cable, twisted pair, air, or other media.

In one example embodiment of the IPTV video delivery system, the SHO 210 distributes content to one or more VHOs 220 which may be spread across a wide geographic territory, such as an entire country. The SHO 210 may, for example, be in a central location for acquisition and aggregation of national-level broadcast television (or linear) programming. A redundant SHO 210 may be provided for backup in case of failure. The SHO 210 may also provide the central point of live television content acquisition and insertion into the IPTV network. Linear programming may be received at the SHO 210 via satellite and processed for delivery to the VHO 220. Live television content may be received from various sources and processed/encoded to codec and bit-rate requirements for the communication network for transmission to the VHO 220 over the high speed communication links. The VHOs 220 are the video distribution points within each DMA or geographic region.

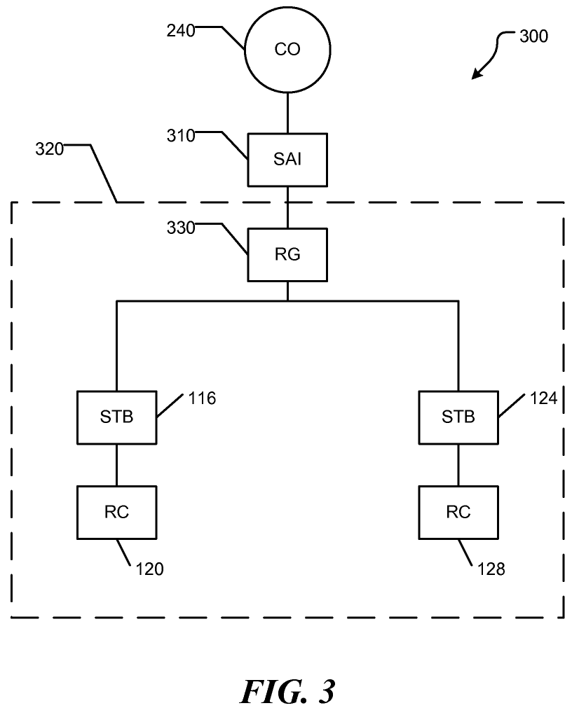

FIG. 3 shows an example network architecture 300 between the CO 240 and customer premises equipment (CPE) 320 of the subscriber 250 shown in FIG. 2. A serving area interface (SAI) or cross box 310 may be connected to the CO 240. SAI 310 may, for example, be located in a weather-proof enclosure proximate the subscriber 250 premises, and may include fiber-to-the-node (FTTN) equipment, such as a digital subscriber line access multiplexer (DSLAM). FTTN equipment may also be located in the CO 240. The customer premises equipment (CPE) 320 includes, for example, a network interface device (not shown) and a residential gateway (RG) 330, with a built-in very-high-bit-rate digital subscriber loop (VDSL) modem or optical network termination (ONT). In either case the RG 330 may be connected to the rest of the home set-top box devices 116 and 124 via an internal network such as an Ethernet. The set-top box devices 116 and 124 each have an associated remote control device 120 and 128 which provides data entry to the set-top box devices to control the IPTV selections from the IPTV data streams.

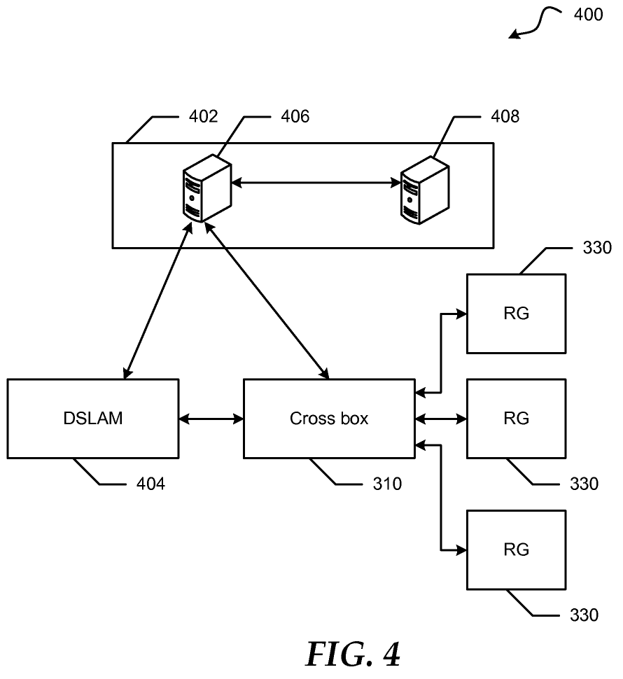

FIG. 4 shows a communication system 400 associated with the IPTV network 300 of FIG. 3. The communication system 400 includes an IPTV backend 402 and a DSLAM 404. The IPTV backend 402 includes a test server 406 and an installation request server 408. The DSLAM 404 is in communication with the test server 406 and with the cross box 310. The test server 406 is in communication with the installation request server 408 and with the cross box 310, which in turn is in communication with multiple RGs 330.

The installation request server 408 can receive a new user installation request indicating a location of the installation request and the type of service requested. For example, the new user installation request can indicate that a user connected to one of the RGs 330 has requested to receive IPTV service from the IPTV system 100 of FIG. 1. The installation request server 408 can forward the new user installation request to the test server 406. After receiving the new user installation request, the test server 406 can determine that an upstream data rate should be tested for each of the user connections between the cross box 310 and each of the RGs 330 and/or between the DSLAM 404 and each of the RGs. A user connection is preferably a twisted pair wire between the cross box 310 and the RG 330 and/or between the DSLAM 404 and the RG 330. It should be understood that the DSLAM 404 may or may not be part of the user connection, and that the DSLAM can be located with the cross box 310 or at the CO 240 of FIG. 3.

The test server 406 sends a test signal over each of the user connections between the cross box 310 and the RGs 330 or between the DSLAM 404 and the RGs. The test server 406 can then monitor an upstream data rate from the RG 330 to the cross box 310 for each of the user connections being tested. Each of the upstream data rates are then compared to a threshold upstream data rate to determine which, if any, of the upstream data rates are below a threshold upstream data rate. The test server 406 can record the upstream data rates and an indication of whether the upstream data rate is below the threshold upstream data rate for each of the user connections of the cross box 310, and can then store the upstream data rates file in memory.

The test server 406 can then determine how many of the user connections have a non-zero upstream data rate that is less than the threshold upstream data rate. The user connections having an upstream data rate of zero are preferably not taken into consideration because a data rate of zero can indicate that a user is not connected to the RG 330. The user connections having an upstream data rate below the threshold upstream data rate can have degradation in the quality of the IPTV service provided over the user connection to the RG 330 and the set-top box devices 116 and 124 of FIG. 3. If the upstream data rate is below the threshold upstream data rate, the IPTV service may not be feasible over the associated user connection because the IPTV signal quality may be too low.

If the number of user connections with upstream data rates below the threshold upstream data rate exceeds a threshold number of user connections, the test server 406 can send the installation request server 408 information indicating that a cable service dispatch ticket should be issued for all of user connections from the cross box 310 to the RGs 330. The cable service dispatch ticket can then be issued to a technician that can service the cross box 310 and/or the DSLAM 404 to correct any problems that might be found in the cross box and/or the DSLAM. Upon the technician arriving at the cross box 310, he or she can replace any bad wires, twist any wire pairs that are currently untwisted, and/or the like to service the cross box. After the technician completes the work at the cross box 310, the test server 406 can be sent information indicating that the cable service dispatch ticket has been completed. The test server 406 can then send the installation request server 408 information indicating that a new user installation ticket can be issued.

In another embodiment, the test server 406 can test each of the user connections between the cross box 310 and each of the RGs 330 at different periodic intervals without first receiving a new user installation request. The testing of the user connections can be similar to that described above. Whenever the number of user connections that have an upstream data rate below the threshold upstream data rate is above the threshold number, the test server 406 can issue a cable service dispatch ticket for the cross box 310. It should be understood that the test server 406 can be in communication with and test the multiple cross boxes 310 and multiple DSLAMs 404 having connections to multiple RGs 330. It should also be understood that the operations performed by the test server 406 and the installation request server 408 can be performed by a single server or other device containing a processor for performing the operations.

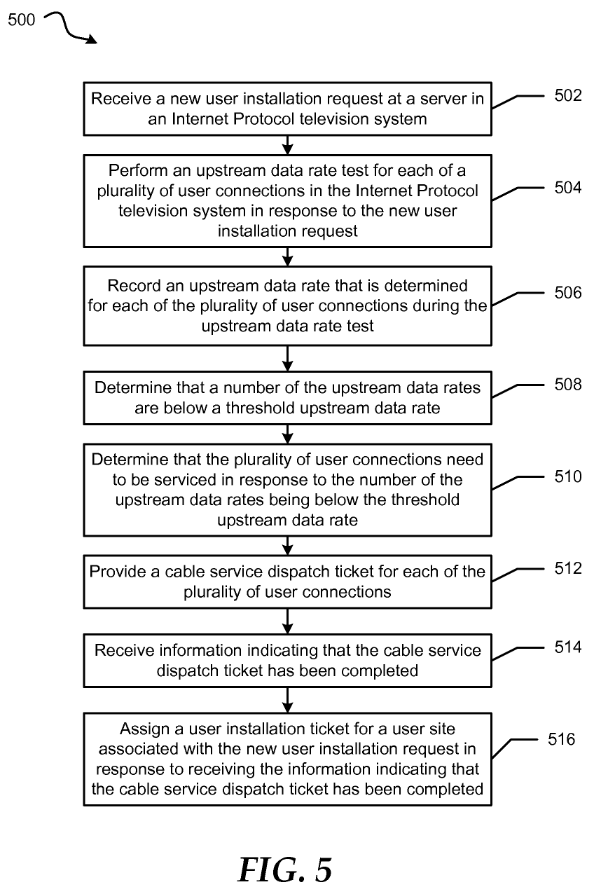

FIG. 5 shows a method 500 for testing the upstream data rates for a plurality of user connections in the communication system 400. At block 502, a new user installation request is received at a server in an IPTV system. An upstream data rate test is performed for each of a plurality of user connections in the IPTV system in response to the new user installation request at block 504. An upstream data rate that is determined for each of the plurality of user connections during the upstream data rate test is recorded at block 506. It is determined that a number of the upstream data rates are below a threshold upstream data rate at block 508.

At block 510, it is determined that the plurality of user connections need to be serviced based on the number of the upstream data rates being below the threshold upstream data rate. A cable service dispatch ticket is provided for each of the plurality of user connections at block 512. At block 514, information indicating that the cable service dispatch ticket has been completed is received. A user installation ticket is assigned for a user site associated with the new user installation request in response to receiving the information indicating that the cable service dispatch ticket has been completed at block 516.

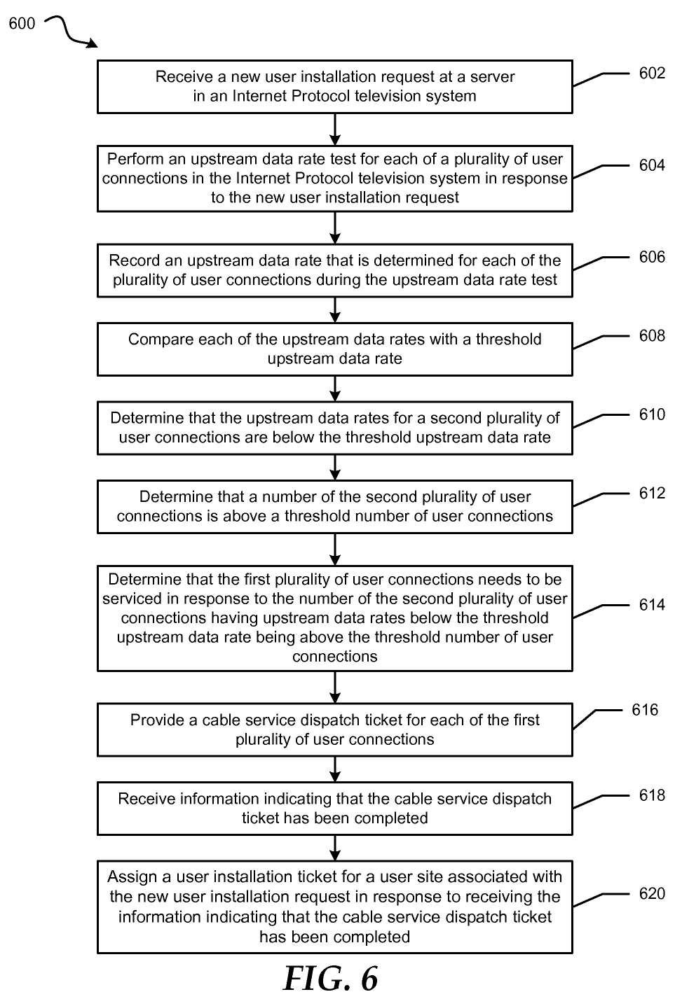

FIG. 6 shows a method 600 for testing the upstream data rates for a plurality of user connections in the communication system 400. At block 602, a new user installation request is received at a server in an IPTV system. An upstream data rate test is performed for each of a plurality of user connections in the IPTV system in response to the new user installation request at block 604. An upstream data rate that is determined for each of the plurality of user connections during the upstream data rate test is recorded at block 606. Each of the upstream data rates are compared with a threshold upstream data rate at block 608. It is determined that the upstream data rates for a second plurality of user connections are below the threshold upstream data rate at block 610.

At block 612, it is determined that a number of the second plurality of user connections is above a threshold number of user connections. In response to the number of the second plurality of user connections having upstream data rates below the threshold upstream data rate being above the threshold number of user connections, it is determined that the first plurality of user connections needs to be serviced at block 614. At block 616, a cable service dispatch ticket is provided for each of the first plurality of user connections. Information indicating that the cable service dispatch ticket has been completed is received at block 618. At block 620, a user installation ticket is assigned for a user site associated with the new user installation request in response to receiving the information indicating that the cable service dispatch ticket has been completed.

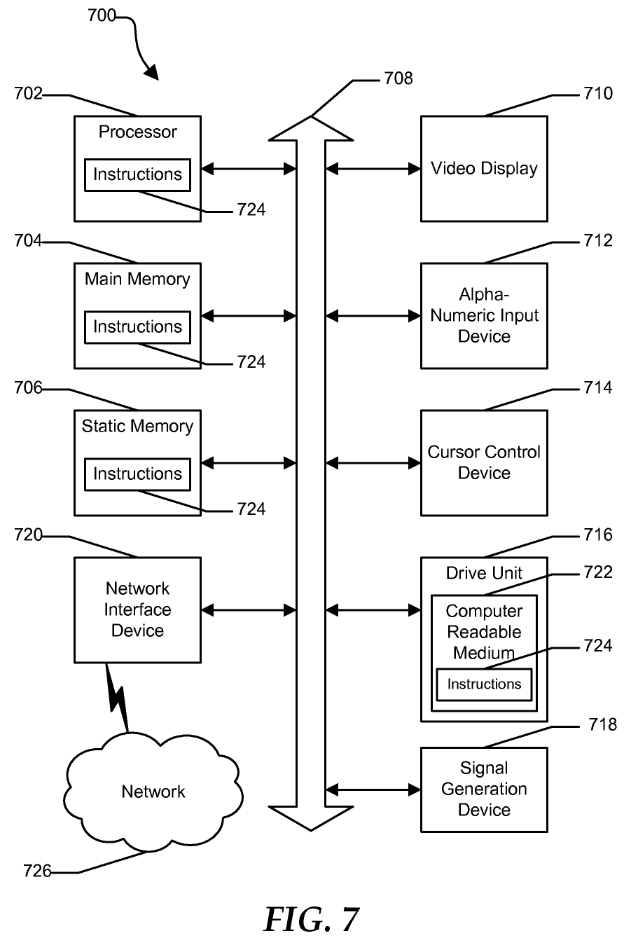

FIG. 7 shows an illustrative embodiment of a general computer system 700 in accordance with at least one embodiment of the present disclosure. The computer system 700 can include a set of instructions that can be executed to cause the computer system to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

The computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media. The network interface device 720 can provide connectivity to a network 726, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
receiving a new user installation request at a server in an Internet Protocol television system;
performing an upstream data rate test for each of a plurality of user connections in the Internet Protocol television system in response to the new user installation request;
recording an upstream data rate that is determined for each of the user connections during the upstream data rate test; and
providing a cable service dispatch ticket for each of the plurality of user connections when a number of the upstream data rates are below a threshold upstream data rate.

2. The method of claim 1 wherein the cable service dispatch ticket for each of the user connections is a service request for a crossbox associated with the user connections.

3. The method of claim 1 wherein the cable service dispatch ticket for each of the user connections is a service request for a digital subscriber line access multiplexer associated with the user connections.

4. The method of claim 1 further comprising:
determining that the user connections need to be serviced in response to the number of the upstream data rates being below the threshold upstream data rate prior to providing the cable service dispatch ticket.

5. The method of claim 1 further comprising:
receiving information indicating that the cable service dispatch ticket has been completed; and
assigning a user installation ticket for a user site associated with the new user installation request in response to receiving the information indicating that the cable service dispatch ticket has been completed.

6. A method comprising:
receiving a new user installation request at a server in an Internet Protocol television system;
performing an upstream data rate test for each of a first plurality of user connections in the Internet Protocol television system in response to the new user installation request;
recording an upstream data rate that is determined for each of the first plurality of user connections during the upstream data rate test;
comparing each of the upstream data rates with a threshold upstream data rate;
determining that the upstream data rates for a second plurality of user connections are below the threshold upstream data rate; and
providing a cable service dispatch ticket for each of the first plurality of user connections when a number of the second plurality of user connections is above a threshold number.

7. The method of claim 6 wherein the cable service dispatch ticket for each of the first plurality of user connections is a service request for a crossbox associated with the first user connections.

8. The method of claim 6 wherein the cable service dispatch ticket for each of the first plurality of user connections is a service request for a digital subscriber line access multiplexer associated with the first plurality of user connections.

9. The method of claim 6 further comprising:
determining that the first plurality of user connections need to be serviced in response to the number of the second plurality of user connections having upstream data rates below the threshold upstream data rate is above the threshold number prior to providing the cable service dispatch ticket.

10. The method of claim 6 further comprising:
receiving information indicating that the cable service dispatch ticket has been completed; and
assigning a user installation ticket for a user site associated with the new user installation request in response to receiving the information indicating that the cable service dispatch ticket has been completed.

11. The method of claim 6 wherein the second plurality of user connections is a subset of the first plurality of user connections.

12. A device comprising:
a processor configured to:
receive a new user installation request at a server in an Internet Protocol television system;
perform an upstream data rate test for each of a plurality of user connections in the Internet Protocol television system in response to the new user installation request;
record an upstream data rate that is determined for each of the user connections during the upstream data rate test; and
provide a cable service dispatch ticket for each of the user connections when a number of the upstream data rates are below a threshold upstream data rate.

13. The device of claim 12 wherein the cable service dispatch ticket for each of the user connections is a service request for a crossbox associated with the user connections.

14. The device of claim 12 wherein the cable service dispatch ticket for each of the user connections is a service request for a digital subscriber line access multiplexer associated with the user connections.

15. The device of claim 12 wherein the processor is further configured to:
determine that the user connections need to be serviced in response to the number of the upstream data rates being below the threshold upstream data rate prior to providing the cable service dispatch ticket.

16. The device of claim 12 wherein the processor is further configured to:
receive information indicating that the cable service dispatch ticket has been completed; and
assign a user installation ticket for a user site associated with the new user installation request in response to receiving the information indicating that the cable service dispatch ticket has been completed.

17. A computer readable medium comprising a plurality of instructions to manipulate a processor, the plurality of instructions comprising:
instructions to receive a new user installation request at a server in an Internet Protocol television system;
instructions to perform an upstream data rate test for each of a first plurality of user connections in the Internet Protocol television system in response to the new user installation request;
instructions to record an upstream data rate that is determined for each of the first plurality of user connections during the upstream data rate test;
instructions to compare each of the upstream data rates with a threshold upstream data rate;
instructions to determine that the upstream data rates for a second plurality of user connections are below the threshold upstream data rate; and
instructions to provide a cable service dispatch ticket for each of the first plurality of user connections when a number of the second plurality of user connections is above a threshold number.

18. The computer readable medium of claim 17 wherein the cable service dispatch ticket for each of the first plurality of user connections is a service request for a crossbox associated with the first plurality of user connections.

19. The computer readable medium of claim 17 wherein the cable service dispatch ticket for each of the first plurality of user connections is a service request for a digital subscriber line access multiplexer associated with the first plurality of user connections.

20. The computer readable medium of claim 17 further comprising:
instructions to determine that the first plurality of user connections need to be serviced in response to the number of the second plurality of user connections having upstream data rates below the threshold upstream data rate is above the threshold number prior to providing the cable service dispatch ticket.

21. The computer readable medium of claim 17 further comprising:
instructions to receive information indicating that the cable service dispatch ticket has been completed; and
instructions to assign a user installation ticket for a user site associated with the new user installation request in response to receiving the information indicating that the cable service dispatch ticket has been completed.

22. The computer readable medium of claim 17 wherein the second plurality of user connections is a subset of the first plurality of user connections.
